(19) United States
(12) Patent Application Publication
(10) Pub. No.: US 2024/0361116 A1
(43) Pub. Date: Oct. 31, 2024

(54) FENCE SLIDE GUIDE

(71) Applicant: CHASE A. DYESS, BRAZORIA, TX (US)

(72) Inventor: CHASE A. DYESS, BRAZORIA, TX (US)

(21) Appl. No.: 18/648,181

(22) Filed: Apr. 26, 2024

Related U.S. Application Data
(60) Provisional application No. 63/498,848, filed on Apr. 28, 2023.

(51) Int. Cl. G01B 5/25; E04H 17/14

(52) U.S. Cl. CPC G01B 5/25; E04H 17/1413

(57) ABSTRACT

A fence slide guide assembly includes a straight edge having a first end in a second end, a pair of vertical side pieces located at each end, and a slide section located between a vertical side piece at the second end. The vertical side pieces are configured to maintain the position of the straight edge in alignment with a fence row. The slide section operates with a pin that allows it to be selectively located a distance beneath the straight edge. Adjustment of the location of the slide section allows for different orientations and alignment with pickets in a picket fence installation project.

### CROSS REFERENCE TO RELATED APPLICATIONS

This application claims the benefit of an earlier filing date and right of priority to U.S. Provisional Application No. 63/498,848, filed 28 Apr. 2023, the contents of which is incorporated by reference herein in its entirety.

### BACKGROUND OF THE INVENTION

### 1. Field of the Invention

The present application relates to a fence building tool, and more particularly to an adjustable fence picket alignment guide.

### 2. Description of Related Art

Building fence is an age-old method of defining plots of land for either defining ownership or specific use areas, such as for corralling livestock or other particular purposes. The practice of fencing dates back as far as records exist and probably existed well before. In England, the land was cultivated in common fields under the feudal system, where peasants were allocated strips of arable land that were used to support the needs of the local village, feudal Lord, or manor.

In the early United States, settlers could claim land in some instances by simply fencing it. Registering the land for ownership followed and parcels became divided between privately owned and government-owned property. Fences of various construction materials were used to mark property boundaries, and surveys began recording and drawing delineations of land parcels.

The American yard, particularly the backyard, is where people like to spend outdoor time. The wooden privacy fence was developed to serve as a boundary between the yard and land ownership. The wooden fence is also used as a privacy screen by separating the backyard visually from the neighbors. The wooden fence is relatively simple in construction and is quite effective if maintained in keeping the backyard a private place to enjoy.

Wooden fences have been a fixture for everything from homesteads to suburban communities. The precision required for the fence to be level and uniformly spaced frequently necessitates the use of a general contractor or other specialist. The basic construction of a wooden fence usually consists of posts set in the ground at intervals, and the posts can vary in construction materials. The posts are typically constructed of wood or metal but can also be of various other materials such as plastic or concrete. The posts are set into the ground and secured by a concrete footing or some other method to keep the post upright and bear the weight of the fence.

The posts are connected by railings that run horizontally along the posts and usually consist of three or more rails evenly spaced vertically. Pickets are placed along these rails by nailing or by screws securing the pickets to the rails. The close proximity of the pickets and the height of the fence determines the amount of privacy and security the fence will create.

A typical wooden fence will have multiple pickets closely attached to each other, depending on the size and amount of fencing required. The fence may require hundreds of pickets. One of the most critical issues in constructing a wooden picket fence is getting the pickets to align in a horizontal line by keeping the vertical alignment between each picket consistent.

Keeping the vertical alignment consistent is complex and must be done correctly, or the resulting fence line will have an uneven horizontal top line of pickets that is very noticeable, undesirable, and generally unacceptable. Various methods are used to keep the alignment when constructing a fence. The methods include string lines and other ways, which have varying degrees of success and can be very difficult to manage. As well as being easy to use incorrectly, the string line can prove to have other factors to increase the difficulty, such as wind or accidentally touching or other factors such as tree limbs or other foreign objects.

Although strides have been made, shortcomings remain. It is desired that an assembly be provided that is configured to help vertically align pickets in the fence during the construction process.

### BRIEF SUMMARY OF THE INVENTION

It is an object of the present application to provide a fence slide guide assembly configured to assist and streamline the in the installation of pickets in a picket fence. The assembly is configured to set an elevated surface to abut pickets to. The assembly is able to be adjusted to different orientations to allow a customized slope in the picket alignments.

It is a further object of the present application that the fence slide guide assembly is configured to nestle into itself for ease of transportation and storage. The assembly is configured to slide along the fence as pickets are sequentially fastened. No need is required to disassemble the assembly as the fence is being built.

Ultimately the invention may take many embodiments. In these ways, the present invention overcomes the disadvantages inherent in the prior art. The more important features have thus been outlined in order that the more detailed description that follows may be better understood and to ensure that the present contribution to the art is appreciated. Additional features will be described hereinafter and will form the subject matter of the claims that follow.

Many objects of the present application will appear from the following description and appended claims, reference being made to the accompanying drawings forming a part of this specification wherein like reference characters designate corresponding parts in the several views.

Before explaining at least one embodiment of the present invention in detail, it is to be understood that the embodiments are not limited in its application to the details of construction and the arrangements of the components set forth in the following description or illustrated in the drawings. The embodiments are capable of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the various purposes of the present design. It is important, therefore, that the claims be regarded as including such equivalent constructions insofar as they do not depart from the spirit and scope of the present application.

### BRIEF DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIG. 1 is a front perspective view of a fence slide guide assembly according to an embodiment of the present application.

FIG. 2 is a rear perspective view of the fence slide guide assembly of FIG. 1.

FIG. 3 is an enlarged rear view of a second end of the fence slide guide assembly of FIG. 2.

FIG. 4 is a front view of the fence slide guide assembly of FIGS. 1 and 2.

FIG. 5 is an enlarged front view of a first end of the fence slide guide assembly of FIG. 4.

While the embodiments and method of the present application is susceptible to various modifications and alternative forms, specific embodiments thereof have been shown by way of example in the drawings and are herein described in detail. It should be understood, however, that the description herein of specific embodiments is not intended to limit the application to the particular embodiment disclosed, but on the contrary, the intention is to cover all modifications, equivalents, and alternatives falling within the spirit and scope of the process of the present application as defined by the appended claims.

### DETAILED DESCRIPTION OF THE INVENTION

Illustrative embodiments of the preferred embodiment are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the embodiments described herein may be oriented in any desired direction.

The embodiments and method in accordance with the present application overcomes one or more of the above-discussed problems commonly associated with the prior art discussed previously. In particular, the fence slide guide is configured to include a straight edge having vertical side pieces at both ends to allow the straight edge to be oriented in different elevated angles relative to the top rail of the picket fence. The assembly is configured to easily permit the installation of pickets in a picket fence by setting an elevated surface to abut the pickets to prior to fastening. These and other unique features are discussed below and illustrated in the accompanying drawings.

The embodiments and method will be understood, both as to its structure and operation, from the accompanying drawings, taken in conjunction with the accompanying description. Several embodiments of the assembly may be presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless otherwise described.

Referring now to the Figures wherein like reference characters identify corresponding or similar elements in form and function throughout the several views. The following Figures describe embodiments of the present application and its associated features. With reference now to the Figures, embodiments of the present application are herein described. It should be noted that the articles “a”, “an”, and “the”, as used in this specification, include plural referents unless the content clearly dictates otherwise.

A string line is one of the well-known ways for keeping the vertical and horizontal lines aligned properly on a wooden picket fence. This approach is often inadequate owing to a variety of reasons such as wind, accidentally touching the string, or having impediments that make it hard for the string to continue in a straight path. The aesthetics of an uneven horizontal line of a wooden fence are not only noticeable and unappealing but are also unsuitable to most building owners for privacy and security.

The Fence Slide Guide assembly of the present application is configured to provide a clever and innovative method and device that allows everyone from contractors to individuals to build a professional-looking wooden picket fencing. The device is made up of a long straight edge that sits on top of the first picket. The straight edge or bar is thick enough to span the picket's top, and horizontal panels extend vertically to hold the bar in place. The bar is extended above and along the top rails. The opposite end of the bar features a vertically extending sliding part that will rest on the top of the higher rail. The end of the bar also has vertical side parts, which have adjustment holes where a pin may be inserted to fix the height.

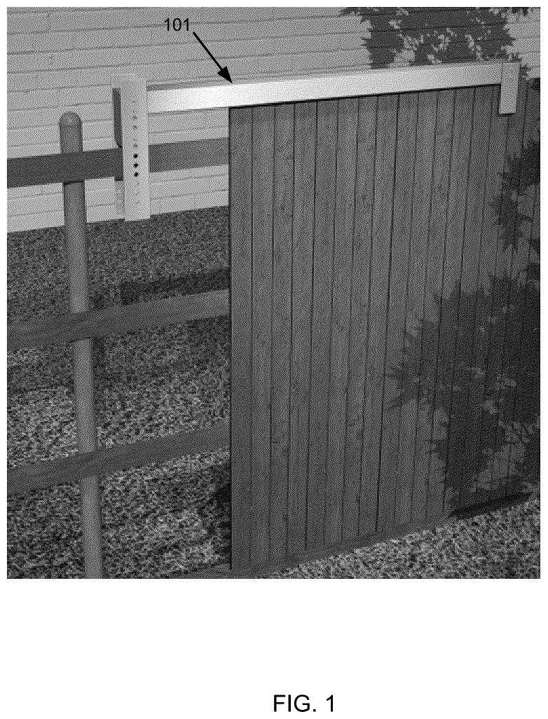

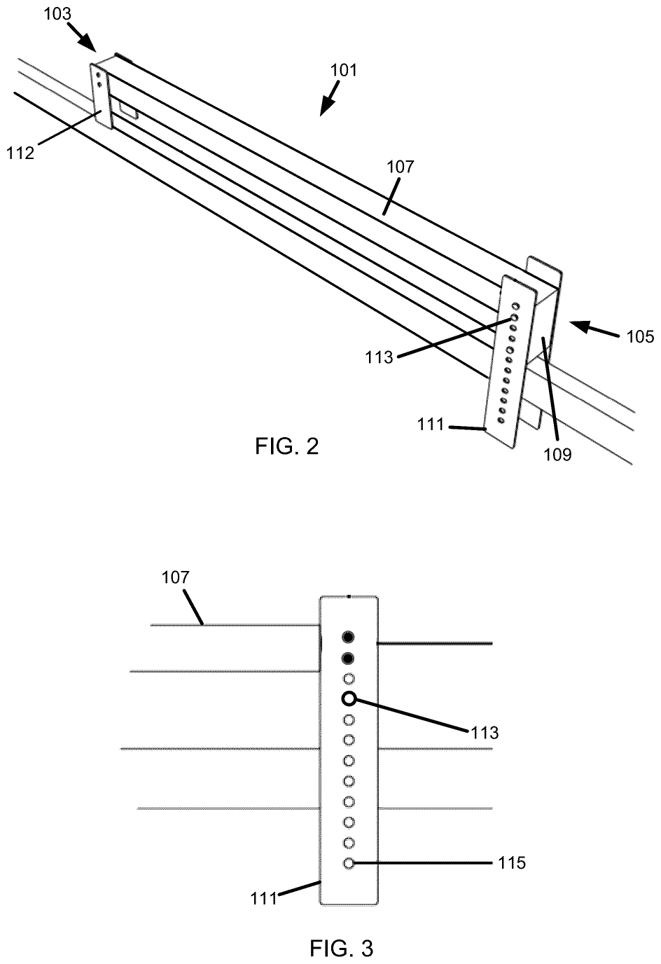

Referring now to FIGS. 1 and 2 in the drawings, perspective views from the front and rear are provided. Fence slide guide assembly 101 is configured to provide an adjustable and easy to operate fence picket alignment guide to assist an operator in ensuring the vertical alignment of pickets during installation of a picket fence. Assembly 101 is made from lightweight and sturdy materials to allow for continued use through each build. Additionally, assembly 101 is intended to be both practical and functional. Its marketability is enhanced by the relative simplicity of manufacturing and reasonably priced components. Improved aesthetics and ease of use benefit the operator, which should generate significant market interest in the product.

The Fence Slide Guide assembly 101 is an intelligent and well-conceived device designed to simplify and create professional-looking results. Assembly 101 is configured to partially straddle an installed picket at a first end 103, and a top rail of the picket fence at a second end 105. Assembly 101 includes a long straight edge 107 designed to extend over and parallel to the top rail of the fence. In operation, an operator sets the first picket at its preferred position relative to the rails of the fence. Assembly 101 is then adjusted to orient the straight edge in a horizontal manner by manipulating assembly 101 at the second end. An operator then locates each successive picket to the side of the prior one wherein the tops abut a lower surface of straight edge 107. Straight edge 107 is configured to ensure the tops of each picket is set uniformly and at an equal height to the pickets to which it neighbors. In other words, straight edge 107 acts as a height alignment guide for the pickets at installation. In FIG. 2, pickets in the fence are now shown and only the top rail is shown.

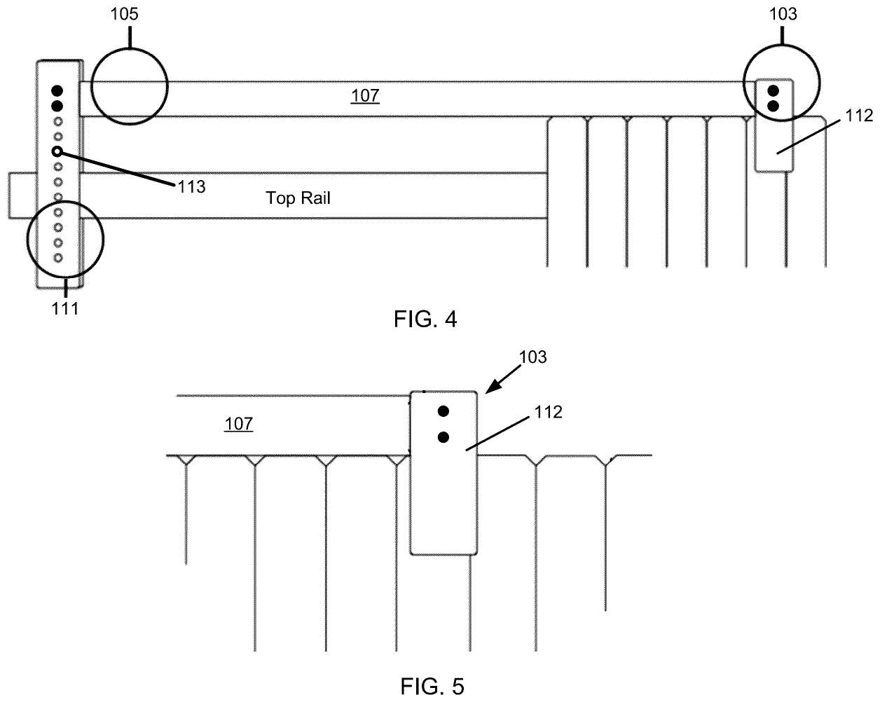

Referring now also to FIGS. 3-5 in the drawings. The straight edge 107 (or bar) is thick enough to straddle the top of the picket. Vertical side piece 112 is located at the first end 103 of straight edge 107. Vertical side piece 112 is fastened to the first end 103 and is configured to translate along sides of straight edge 107 and extend below its lower surface so as to extend along either sides of a picket. Vertical side piece 112 is configured to prevent straight edge 107 from falling off the top surface of the pickets.

The second end 105 of the bar 107 also features a vertical side piece 111, or in this case a pair of vertical side pieces 111. Vertical side piece 111 is fastened to straight edge 107 at the second end 105. Vertical side piece 111 is configured to permit assembly 101 to adjust in height to different picket heights or top rail heights of a fence. Vertical side pieces 111 are similar in form and function to that of vertical side pieces 112 except that it is longer and includes adjustment holes 115 with a pin 113. Vertical side piece 111 is configured to extend along the sides of straight edge 107. Holes 115 are situated on both sides of vertical side piece 111 and are oriented so as to be located concentrically with its corresponding side. Pin 113 is configured to pass through holes 115 on opposing ends.

The bar 107 extends for a distance above and along the top rails of the fence. The second end 105 of the bar has a slide section 109 that extends vertically down beneath bar 107 between vertical side piece 111. Slide section 109 is selectively located and secured via pin 113 such that slide section 109 will rest on the top of the upper rail thereby elevating straight edge 107 above the top rail at a selected height. It should be remembered that the lower surface of straight edge 107 rests atop the pickets at the first end 103 while second end 105 is distal from the pickets and it elevated to a particular height above the top rail through slide section 109 and pin 113.

The pin 113 is placed at the desired height through holes 115 so secure section 109 on the fence rail at a height sufficient to align future installed pickets placed from first end 103 toward second end 105. Ideally straight edge 107 is level from top of the pickets relative to the height of the rail. Once the height is set, it is a simple matter of aligning each picket top to the straight edge of the horizontal bar 107 to create perfect alignment of the pickets. The Fence Slide Guide assembly 101 can be continually slid down the upper rail for the length of the fence section keeping the pickets in perfect alignment when secured to the railing. At any time an operator may remove and reinsert pin 113 from and into any of the holes 115.

The Fence Slide Guide assembly 101 can be folded for transport and storage, keeping the device safe from damage. It should be understood that the length of bar 107 is a design choice as it may be longer or shorter than that depicted. It is also understood that the vertical side piece 111 is adjustable in position along the side of bar 107. The idea is that the position of piece 111 is adjusted up and down so as to extend over the sides of the top rail to ensure stability. Where a pair of vertical pieces are used, they may be coupled so as to operate as a single unit. Similar to that of second end 105, first end 103 includes a plurality of vertical panels to located the first end 103 of bar 107 over the pickets.

The fence guide slide of the present application includes many advantages over the prior art including at least the following points. The invention is constructed of sturdy lightweight materials. A straight edge is used for aligning pickets as well as incorporating the capability of adjustable heights. The invention is configured to slide along an upper rail of pickets so as to maintain the same distance for aligning the pickets upon installation. An advantage also includes eliminating string and other methods that are commonly used when aligning pickets. This allows the invention of the present application to save time and money. When not in use the invention may be folded and stored for transport and can be available for anyone building fences.

The particular embodiments disclosed above are illustrative only, as the application may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. It is apparent that an application with significant advantages has been described and illustrated. Although the present application is shown in a limited number of forms, it is not limited to just these forms, but is amenable to various changes and modifications without departing from the spirit thereof.

What is claimed is:

1. A fence slide guide assembly for constructing a picket fence, comprising:
a straight edge having a first end and a second end;
a first vertical side piece coupled to the straight edge at the first end;
a second vertical side piece coupled to the straight edge at the second end, the second vertical side piece includes corresponding concentric holes;
a slide section located between the second vertical side piece and beneath the straight edge at the second end; and
a pin configured to pass through concentric holes in the second vertical side piece and secure the slide section at a location beneath the straight edge.

2. The assembly of claim 1, wherein the second vertical side piece extends below the first vertical side piece.

3. The assembly of claim 1, wherein the first end of the straight edge rests upon pickets of the picket fence.

4. The assembly of claim 1, wherein the second end of the straight edge is elevated above a top rail of the picket fence.

5. The assembly of claim 1, wherein the location of the slide section is adjustable.

6. The assembly of claim 1, wherein the pin is removable.

7. The assembly of claim 1, wherein the second vertical side piece extends below a top rail of the picket fence.

8. A fence slide guide assembly for constructing a picket fence, comprising:
a straight edge having a first end and a second end;
a first vertical side piece coupled to the straight edge at the first end;
a second vertical side piece coupled to the straight edge at the second end, the second vertical side piece includes corresponding concentric holes; and
a pin configured to pass through concentric holes in the second vertical side piece and secure the second end at a location relative to the first end.

9. The assembly of claim 8, wherein the second vertical side piece extends below the first vertical side piece.

10. The assembly of claim 8, wherein the pin is removable.

11. The assembly of claim 8, wherein the first end of the straight edge rests upon pickets of the picket fence.

12. The assembly of claim 8, wherein the second end of the straight edge is elevated above a top rail of the picket fence.

13. The assembly of claim 8, further comprising:
a slide section located between the second vertical side piece and beneath the straight edge at the second end.

14. The assembly of claim 13, wherein the location of the slide section is adjustable.
